(19) United States
(12) Patent Application Publication
(10) Pub. No.: US 2013/0037333 A1
(43) Pub. Date: Feb. 14, 2013

(54) MULTIFUNCTIONAL LOCOMOTOR

(71) Applicant: Rosana Antunes de Sousa, Belo Horizonte (BR)

(72) Inventor: Rosana Antunes de Sousa, Belo Horizonte (BR)

(21) Appl. No.: 13/642,591

(22) PCT Filed: Apr. 19, 2011
(86) PCT No.: PCT/BR11/00115

§ 371 Date: Oct. 22, 2012

(30) Foreign Application Priority Data
Apr. 22, 2010 (BR) PI 1001282-6

(51) Int. Cl. A61G 5/10; A61G 5/04

(52) U.S. Cl. 180/19.1; 280/47.38

(57) ABSTRACT

MULTIFUNCTIONAL LOCOMOTOR APPARATUS, which conjugates the function of making someone move in standing position, and also sitting in only one object, thus providing more comfort, health, and life quality for handicapped and bedridden people the apparatus including three modules, being each a lower module, an intermediate module, and an upper module, basically comprised of a preferably tubular structure with at least three vertical elements that compose a tubular structure, which is supported by a gripping circular base and yet containing several devices coupled to said tubular structure.

### TECHNICAL FIELD

The disclosure concerns locomotion of handicapped and bedridden, ergonomics and comfort for the handicapped and the bedridden, and health and life quality. The present disclosure further relates to a multifunctional locomotor apparatus, which combines the function of making the person moves in standing position, and also sitting in only one object, thus providing more comfort, health and life quality for handicapped and bedridden people.

### BACKGROUND

Along history, the society has formulated a definition of what normality is, and considers complete and productive only people who present no physical or mental disabilities, not caring if they are able to achieve as much as those considered normal.

In Middle Ages, approximately in 5^{th} century AC until the end of the 15^{th} century, handicapped people represented two feelings: fun and dread. Handicapped people were either laughing matter, being even used as jesters by the nobility, or were deemed scary since they were compared to “witches” and “demons”, therefore being looked upon with suspicion by society.

In order to make people have a positive attitude towards handicapped people, words like “paralytic”, “paralyzed”, “crippled”, “deformed”, which meanings showed the stereotyped feelings society attributed to them, were replaced by the word “handicapped”, and more recently UN globally spread the phrase “people with disabilities”.

Disability is all and any endangerment affecting one's integrity and damaging one's locomotion, coordination of movements, speech, information comprehension, spatial orientation or perceiving and contacting other people.

Walking frames are presently provided with casters and only allow people with movement of legs to stand. People who are paraplegic, quadriplegic, and bedridden, without movement and force in legs, and body balance cannot be in standing position and move with a walking frame. Other existing apparatuses that allow the person to stand provide no form of dislocation, and only allow them to be in a standing position. Besides, the existing wheelchairs on which they move are very large in its length (approximately 1.40 m), due to large wheels and foot support, which are extended. This makes difficult for paraplegic people to approximate and have access to dishwashing sinks, stoves, ironing machines, wardrobes, since the length and depth of traditional wheelchairs hinders people from accessing such places, performing simple tasks, and the fact that they are chairs implies the person will only be in a single position of use, i.e. sitting still. It is necessary to mention that people with diagnosis of paraplegia and tetraplegia live their routines either in horizontal, lying in beds, or sitting on wheelchairs.

In order to solve such inconveniences, the present invention was developed, though which paraplegic, quadriplegic, and bedridden people can be in a standing position, move, using the casters or the apparatus' engine, are able to perform several tasks, and use the same apparatus as wheelchair and bath chair. Through a process of immobilizing legs and trunk, handicapped people are able to be in a standing position, so they can move and perform some routine tasks any person not having such limitations does, such as: be close to the stove and cook, reach the dishwashing sink to wash the dishes, reach the bathroom sink to brush their teeth and comb their hair, reach the washing machine, reach the ironing board to iron clothes, reach the wardrobes to take clothes off the hangers, and grab utensils from higher places, since the person will be in a standing position, or if he/she is using one of the variations of the apparatus, such as wheelchair, he/she will be sitting on a smaller chair, which gives access to several environments, pieces of furniture, and domestic appliances. The apparatus is a unity; however, by changing the composition of its pieces and accessories, the apparatus can turn into 6 variations: (apparatus to put a quadriplegic in standing position, apparatus to put a paraplegic in standing position, apparatus to put a paraplegic in standing position (simple variation), wheelchair for quadriplegic, wheelchair for paraplegic, and bath chair.

### BRIEF SUMMARY

Progresses brought to state of art by “multifunctional locomotor apparatus”, disclosed herein.

The “Multifunctional Locomotor Apparatus” allows people to be in a standing position, so as to have more accessibility and life quality. In the dictionary, the word “accessible” means “able to be accessed; friendly and easy to talk to; approachable”. And the purpose is to make people with disabilities reach furniture, domestic appliances, wardrobes, perform simple tasks that said “regular people” can perform without much trouble.

The apparatus has a large social outreach, since not only paraplegic and quadriplegic, but also people with reduced mobility will benefit from it.

One of the main advantages of the present “Multifunctional Locomotor Apparatus” is that, when someone is put in a standing position, they feel a sensation of independence, freedom and equality towards other people, since they are able to see the world from a long lost perspective, since from paraplegics' and quadriplegics' point of view, the world is only seen from an lower position.

### BRIEF DESCRIPTION OF THE DRAWINGS

For a perfect understanding of the principles applied in the development of the present “Multifunctional Locomotor Apparatus”, a preferred embodiment is presented, for illustration purposes, that offers various possibilities for adjustments, customized adaptations, as well as the use of several other accessories.

FIG. 1 shows a perspective view of the complete apparatus;

FIG. 2 shows a perspective view of the complete apparatus with more numeral references;

FIG. 3 shows a perspective view of the upper module;

FIG. 4 shows a perspective view of the intermediate module;

FIG. 5 shows a perspective view of the lower module;

FIG. 6 shows a perspective view of the apparatus comprised of lower and intermediate modules. On example 1: Use oriented to paraplegic people;

FIG. 7 shows a perspective view of the complete apparatus. On example 2: Use oriented to tetraplegic people;

FIG. 8 shows a perspective view of the apparatus comprised of lower and intermediate modules. On example 3: a more robust and firmer wheelchair;

FIG. 9 shows a perspective view of the apparatus comprised of lower and upper modules. On example 4: another variation for the wheelchair;

FIG. 10 shows a perspective view of the apparatus comprised of lower and upper modules. On example 5: bath chair—replacement of seat 21 with seat 17;

FIG. 11 shows a perspective view of the apparatus comprised of lower and upper modules. On example 6: by removing seat 17, it transforms into a simple version enabling paraplegic and bedridden people to be in a standing position; and

FIG. 12 shows a perspective view of the apparatus including the meal tray 16.

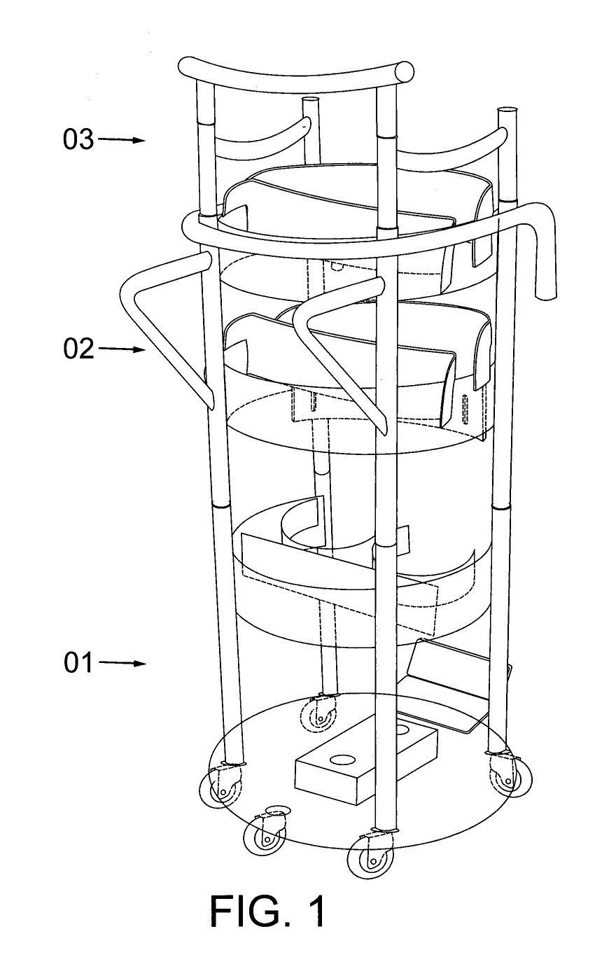

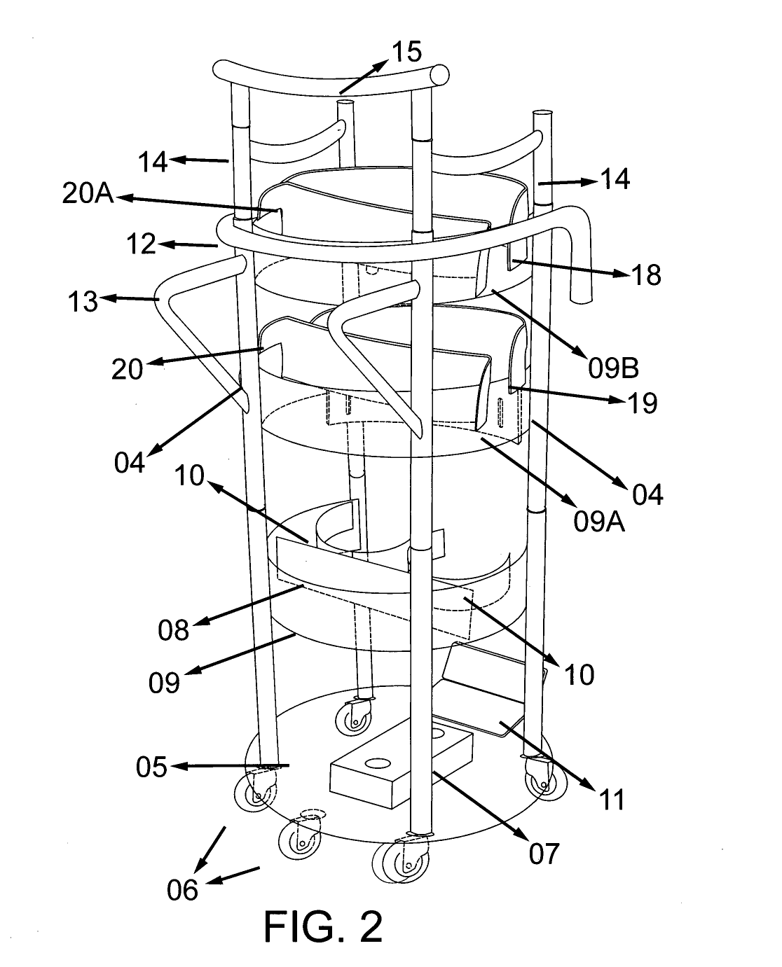

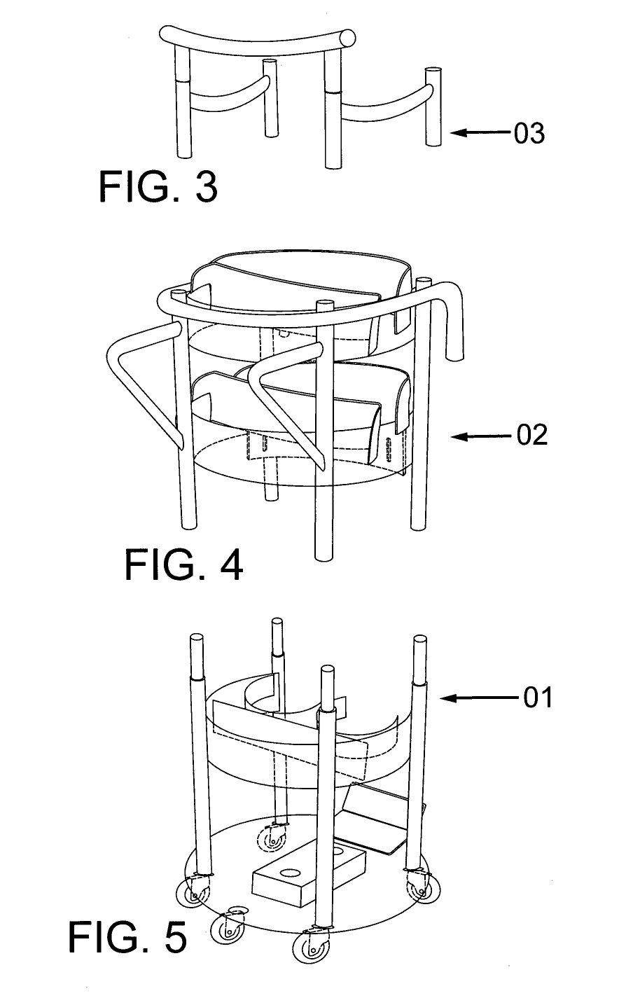

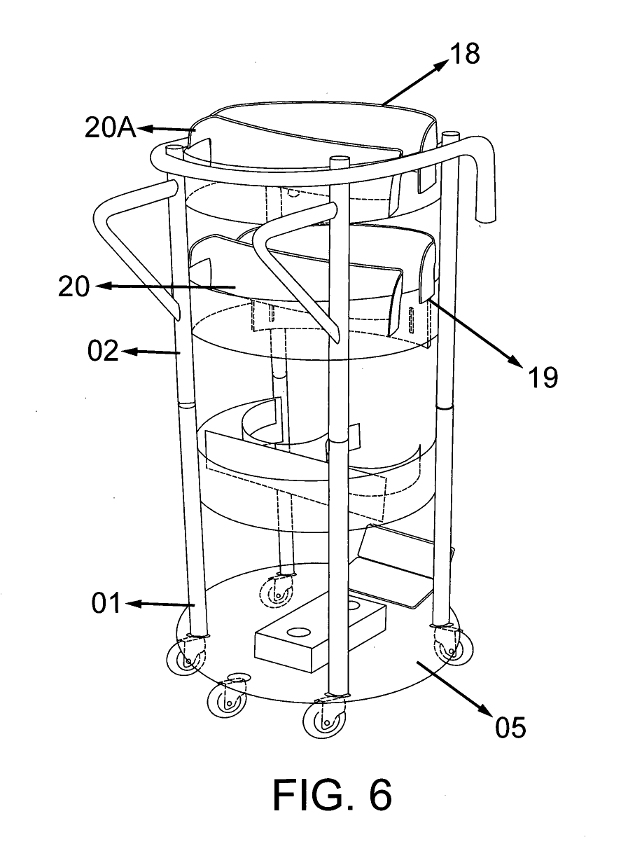

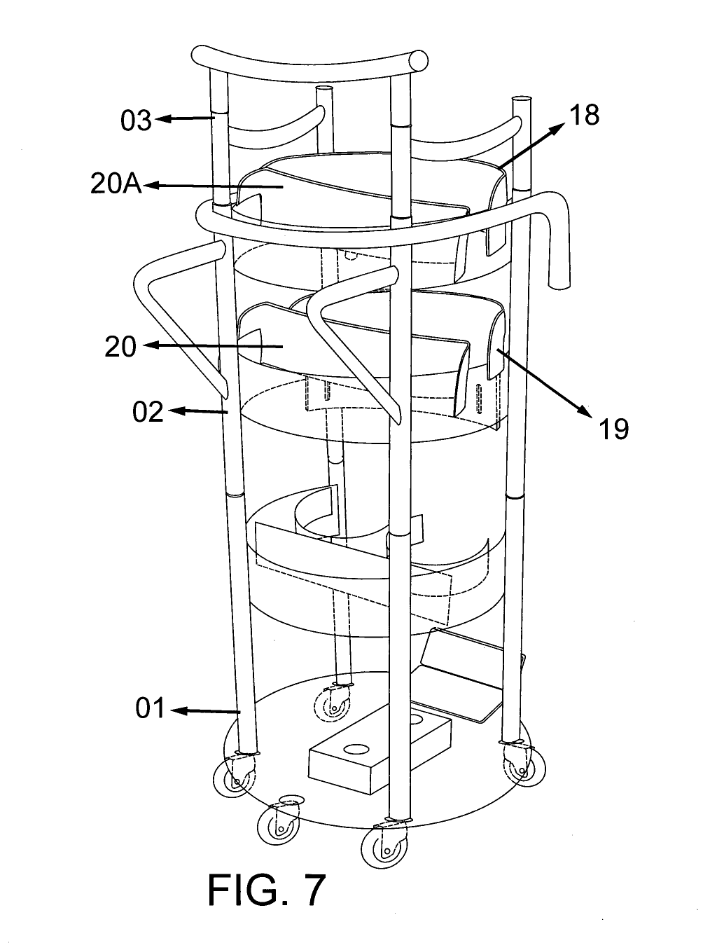

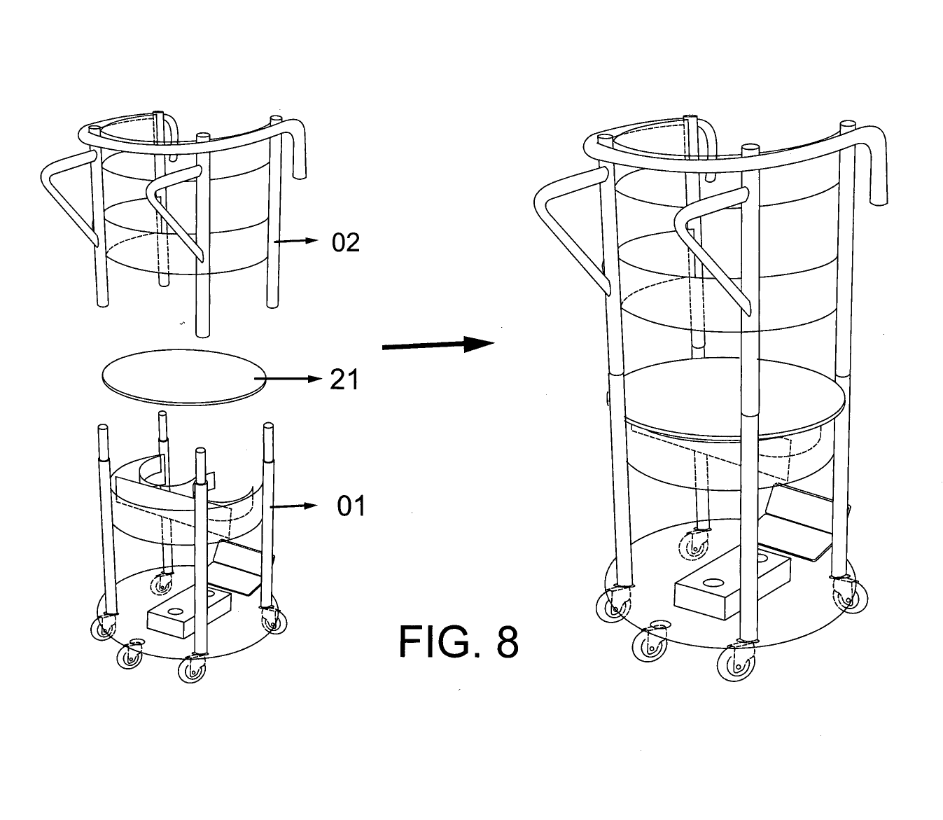

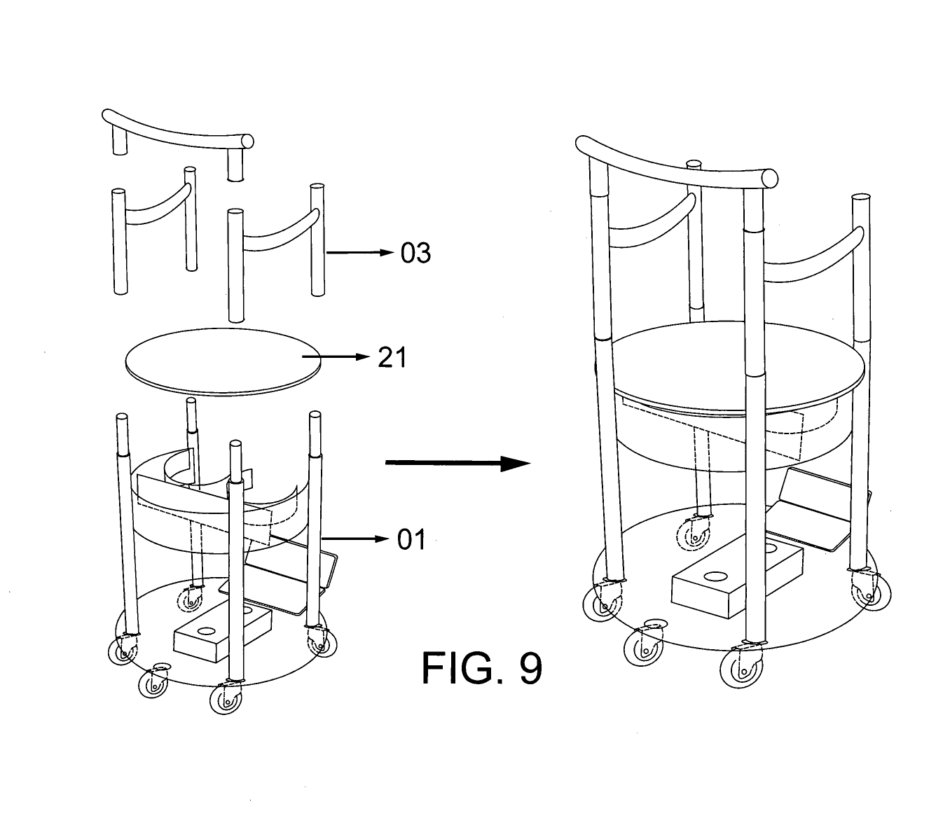

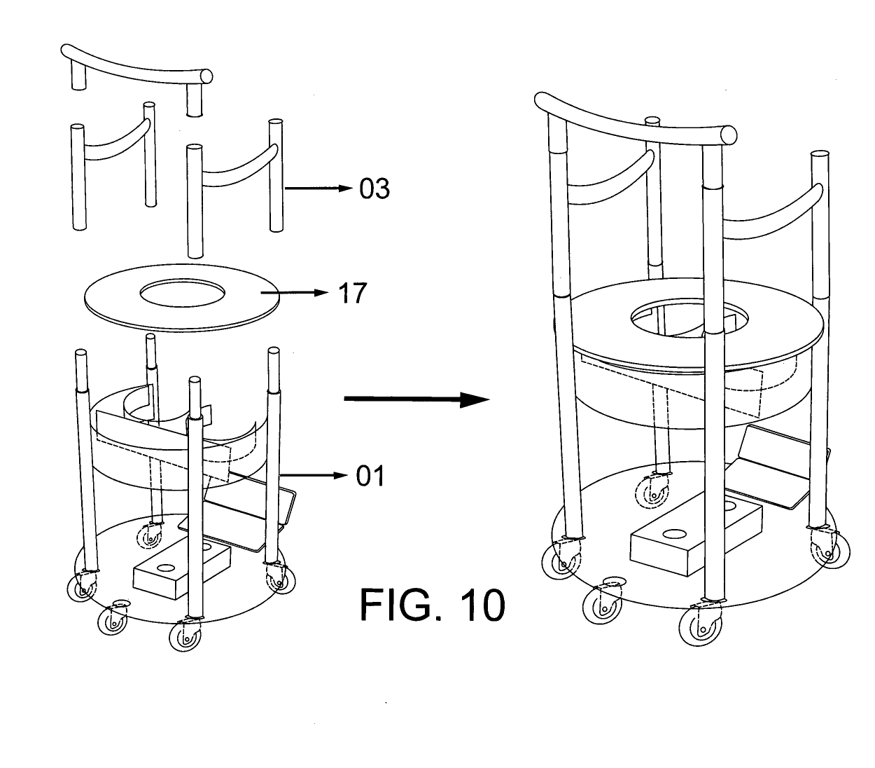

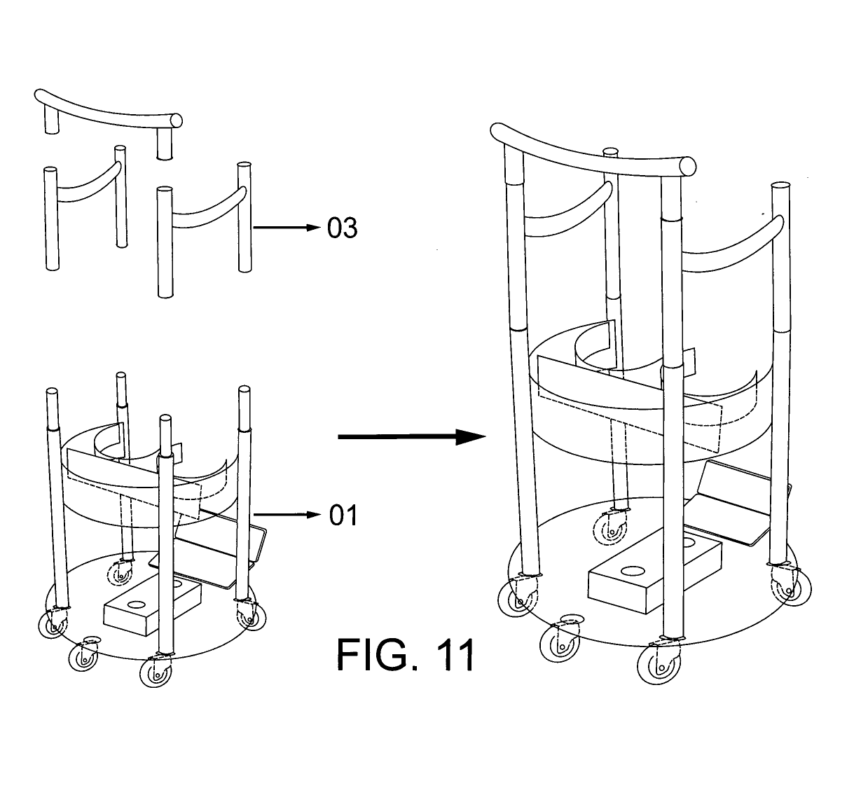

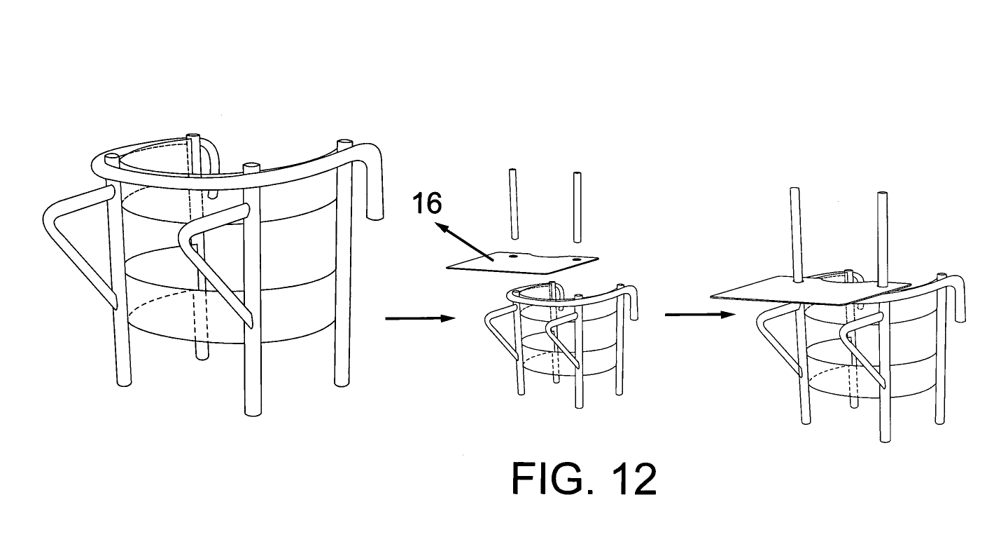

### DETAILED DESCRIPTION

By observation of above figures, a detailed description of the present invention is set forth below, which may include several accessories that are not shown, but are integral part of the scope, especially the replacement of some elements that would perform the same technical function.

Modules 01, 02 and 03 are basically comprised of a preferably tubular structure comprised of three, four or more vertical elements 04, being, in the illustrated example, two in the frontal portion and two in the posterior portion, which are supported over a gripping circular base 05. These tubes are interconnected and affixed by pressure on appropriate fittings by means of pins, stoppers, and the like.

The lower module 01 is basically comprised of a tubular structure 04, with a gripping circular plate 05 for foot support allowing the user to be in a standing position. Such structural base also has five casters 06 in its lower portion and an electric engine 07 oriented to allow the dislocation of the “Multifunctional Locomotor Apparatus”.

On the upper portion of the lower module 01 there is a plate 09 forming a semicircle in the inner portion of the tubular structure 04, which is provided with a straight plate 08 with two smaller quilted rims 10 to provide support and firmness for the knees.

The intermediate module 02 is comprised of a tubular structure 04 containing two semicircle-shaped plates 09A and 09B, being the first plate 09A designed to secure the hips, and second plate 09B designed to secure the waist, two adjusting accessories 20 and 20A in the frontal portion of the “Multifunctional locomotor apparatus” being respectively designed for adjusting thighs and belly, which are fitted onto plates 09A and 09B.

It is yet foreseen for such intermediate module 02 a safety support 13 secured to the tubular structure 04.

Also in this intermediate module 02 it is foreseen a semicircular tube 12 involving a tubular structure 04, being the same oriented to support user's hands, said semicircular tube 12 also having in its posterior portion a curvature oriented downwards to allow another person to push the apparatus.

For better ergonomic adjustment, it is yet foreseen in the posterior portion the inclusion of a smaller semicircle-shaped rim 18, differing from rims 09, 09A, and 9B, which adjust the user's body by the back, around the waist.

For this intermediate module 02 it is further foreseen another semicircle-shaped rim 19, larger, also provided with cuts in its end for fitting the second rim 09A, involving the hip area, in the back part.

The upper module 03 of the apparatus is comprised of the tubular structure 04 and contains two arm supports 14, a neck support 15, mainly oriented for holding arms and neck of quadriplegic people with no neck support.

The three modules 01, 02, and 03 when fitted form the apparatus as a whole.

In order to provide more operability and functionality, four more accessories were developed:
1 plated tray with 2 smaller bores 16, for meals.
1 seat provided with an opening in shape of a toilet seat lid 17.
1 quilted seat or a seat provided with a loose foam cushion 21.
1 four point seat belt. (To be used on the body trunk).

Examples of various uses.

Herein follows six possible uses for the “Multifunctional Locomotor Apparatus”.

Example 1: Use oriented to paraplegic people—the apparatus comprised by modules 01 and 02.

Example 2: Use oriented to tetraplegic people—the apparatus comprised by modules 01, 02, and 03.

Example 3: the apparatus turns into a more robust and firmer wheelchair—the lower module 01 and the intermediate module 02, fitted and with the seat 21 placed over the rim 09 of the inferior portion 01 of the apparatus, since the two rims 09A and 09B of the intermediate module 02 protect the user's trunk and arms.

Example 4: another variation for the wheelchair: by fitting the upper module 03 of the apparatus to the lower module 01 of the apparatus, by totally removing the intermediate module 02 and placing the cushioned seat 21, the multifunctional apparatus turns in to a smaller chair with a design more advanced than existing chairs. The arm supports 14 turn into hand supports and the neck support 15 turn into back support, with the user in a sitting position.

Example 5: by keeping the apparatus in above mentioned variation, and replacing the seat 21 with seat 17, the multifunctional apparatus turns into a bath chair, since the tray 17 has a design in shape of a toilet seat lid.

Example 6: by keeping the apparatus in above mentioned variation 5, and removing the seat 17, it turns into a simpler version of the “Multifunctional Locomotor Apparatus” enabling paraplegic and bedridden people to be in a standing position.

The tray 16 serves as a meal tray if supported on the frontal portion of the apparatus, over the circular tube 12 of the intermediate portion 02. It is secured by fitting the upper portion 03 of the apparatus without placing support 15.

1. MULTIFUNCTIONAL LOCOMOTOR APPARATUS, which conjugates the function of making the user move in standing position, and also sitting in only one object, comprising: a lower module, an intermediate module and an upper module, which are basically assembled on a preferably tubular structure comprised of at least three vertical elements that compose a tubular structure, which is supported by a gripping circular base and including several devices coupled to said tubular structure.

2. MULTIFUNCTIONAL LOCOMOTOR APPARATUS, according to claim 1, wherein the lower module comprises a tubular structure, with a gripping circular plate for support of feet and allowing the user to stand up, being said gripping circular plate and provided with casters in a lower portion, an electric engine and a foot rest, foldable and retractable; the lower module, in an upper portion has a plate forming a semicircle in an internal portion of the tubular structure, which is provided with a straight plate with two smaller quilted rims to provide support and firmness to user's knees.

3. MULTIFUNCTIONAL LOCOMOTOR APPARATUS, according to claim 1, wherein the intermediate module is comprises the tubular structure containing two plates and semicircle-shaped, being the a first plate to secure the hips, and the a second plate to secure the waist; being provided with two adjusting accessories and in a frontal portion, a safety support secured to the tubular structure, a semicircular tube involving a tubular structure oriented to support user's hands, said semicircular tube et having in its posteriorportion a curvature oriented downwards and also a smaller semicircle-shaped rim, and another larger semicircle-shaped rim, also provided with cuts in its end for fitting the second rim involving the hip area, in the back part.

4. MULTIFUNCTIONAL LOCOMOTOR APPARATUS, according to claim 1, wherein upper module is comprised by the tubular structure and containing two arm supports, as well as a neck support.

5. MULTIFUNCTIONAL LOCOMOTOR APPARATUS, according to claim 1, having yet a plated tray with two smaller bores for meals, a seat provided with an opening in shape of a toilet seat lid, a quilted seat or a seat provided with a loose foam cushion, and a four point seat belt.
